(19) United States
(12) Patent Application Publication
(10) Pub. No.: US 2026/0098799 A1
(43) Pub. Date: Apr. 9, 2026

(54) BIOSIGNAL MEASURING APPARATUS

(71) Applicant: WONTECH CO., LTD., Daejeon (KR)

(72) Inventors: Jong Won KIM, Seongnam (KR); Jung Hyun KIM, Seongnam (KR); Young Seok SEO, Sejong (KR)

(21) Appl. No.: 19/330,845

(22) Filed: Sep. 17, 2025

(30) Foreign Application Priority Data
Oct. 5, 2024 (KR) 10-2024-0179644

(51) Int. Cl. G01N 21/01

(52) U.S. Cl. CPC G01N 21/01; G01N 2021/0181

(57) ABSTRACT

Proposed is a biosignal measuring apparatus, which includes a housing including a base plate, and a column that is coupled to the base plate in a z-axis direction, is formed to have an internal hollow space, and has one surface formed in a curved shape, a power supply part provided on a first side of the housing and configured to supply power, a control part provided on the first side of the housing and configured to control operation by receiving power from the power supply part, an image processing part connected to the control part and configured to perform preprocessing and postprocessing of an image, an image determination part configured to determine quality of the image processed by the image processing part, and a control box coupled to a second side of the housing.

### CROSS REFERENCE TO RELATED APPLICATION

The present application claims priority to Korean Patent Application No. 10-2024-1079644, filed December 05, 2024, the entire contents of which are incorporated herein for all purposes by this reference.

### BACKGROUND OF THE INVENTION

### Field of the Invention

The present disclosure relates generally to a biosignal measuring apparatus. More particularly, the present disclosure relates to a biosignal measuring apparatus in which a module is movable according to the position, height, and angle of a user in order to acquire biosignals of the user.

### Description of the Related Art

The most common method used in photoplethysmography (PPG), which employs light, is to analyze the amount of transmitted light after the human body is illuminated with the light. This is explained by the Beer–Lambert law, which states that absorbance is proportional to both the concentration of the absorbing substance and the thickness of the absorbing layer. According to this law, changes in the amount of transmitted light result to signals that are proportional to changes in the volume of the transmitting substance. Therefore, even without measuring of the absorbance of the substance, PPG can be used to determine conditions of the heart, etc.

Recently, technologies that utilize remote photoplethysmography (rPPG), representing an advancement over conventional photoplethysmography (PPG), have been emerged. As one of the most widely used PPG-based techniques for detecting cardiac signals, a device such as a smartphone, in which a camera and light source are placed in close proximity, is brought into direct contact with the human body to illuminate the human body with light and immediately measure transmitted light to acquire PPG signals. More recently, however, rPPG-based technologies, in which changes in blood vessel volume are determined from signals acquired from video captured by a camera, have been continuously researched and developed.

Technologies using rPPG do not require direct contact between a subject and a measurement device, and therefore can be applied in various places equipped with cameras, such as airport immigration control centers, and remote medical treatment environments.

However, the rPPG-based technology has a problem in that noise generated by ambient light and movement of a subject during the process of capturing the subject with a camera has a significant impact on a signal. Additionally, there is a need for the product to allow easy adjustment of settings and mobility to accommodate user convenience.

### Document of Related Art

(Patent Document 1) Korean Patent Application Publication No. 10-2021-0084400A

### SUMMARY OF THE INVENTION

Accordingly, the present disclosure has been made keeping in mind the above problems occurring in the related art, and an objective of the present disclosure is to provide a biosignal measuring apparatus that automatically performs height adjustment according to the height of a user so that the face of the user can be positioned at the center of an image capturing device.

An objective of the present disclosure is to provide a biosignal measuring apparatus that is capable of performing the automatic angle control of the image capturing device and the automatic illuminance control of a lighting part by analyzing the influence of the surrounding environment when acquiring a source image according to the influence of the surrounding environment.

In addition, an objective of the present disclosure is to provide a biosignal measuring apparatus that illuminates a user with a laser of infrared wavelength and an RGB camera, captures video of a reflected R value and changes in the laser of infrared wavelength, and analyzes the captured video to measure biosignals of the user.

In order to achieve the objectives of the present disclosure, there is provided a biosignal measuring apparatus including: a housing including a base plate, and a column that is coupled to the base plate in a z-axis direction, is formed to have an internal hollow space, and has one surface formed in a curved shape; a power supply part provided on a first side of the housing and configured to supply power; a control part provided on the first side of the housing and configured to control operation by receiving power from the power supply part; an image processing part connected to the control part and configured to perform preprocessing and postprocessing of an image; an image determination part configured to determine quality of the image processed by the image processing part; and a control box provided by being coupled to a second side of the housing, and configured to receive power from the power supply part and to be operated by control of the control part, wherein the control box includes: multiple sensor parts configured to measure biosignals of a user; a display part configured to display biosignal measurement data of each of the sensor parts; a data input part configured to acquire video or audio data of a user; a lighting part whose operation is controlled by the control part; and a light output part configured to illuminate a user with light of a specific wavelength.

A movement line may be provided inside the column, wherein the movement line is a rail.

The movement line may operate by receiving power from the power supply part, be controlled by operation control of the control part, and include a coupling member that is coupled to the control box.

A first end of the coupling member may be coupled to and fixed to the movement line, and a second end of the coupling member may be coupled to one side of the control box, so that the control box may move together with movement of the movement line.

A wavelength of light emitted from the light output part may be at least one of 660nm and 940nm.

The sensor part may include at least one of multiple illuminance sensors for detecting an amount of light in a surrounding environment, a position detection sensor for detecting a position of the control box, an angle detection sensor for detecting an angle of the control box, an impact detection sensor for detecting a collision of the control box, an identification sensor for identifying unique identification information of a user, and an iris recognition sensor for recognizing an iris of a user.

The control box may further include an angle adjusting part provided detachably inside the data input part and configured to adjust an angle under control of the control part.

The data input part may include an image capturing device coupled to the angle adjusting part so as to acquire a video image of a user, and a voice input device configured to acquire voice data of a user.

The image capturing device may capture an image of a user, including an imaging region of the user after light is emitted from the light output part, and an angle of the image capturing device may be controlled so that the captured image approximates brightness, saturation, luminance, and illuminance values preset by the image determination part.

The lighting part may be detachably provided on one side of an image capturing device, and an angle thereof may be controlled together when an angle of the image capturing device is controlled by angle control of an angle adjusting part.

When an average sensing value of multiple illuminance sensors of the sensor part that detect an amount of light of a surrounding environment is less than 600 Lux, the lighting part may be controlled to illuminate a user with light thereof.

According to these features, the biosignal measuring apparatus of the present disclosure is capable of adjusting the height of the apparatus in accordance with the height of each user, thereby reducing errors caused by a video data collection angle and thus improving the reliability of a resultant value.

Furthermore, the biosignal measuring apparatus of the present disclosure analyzes an influence of a surrounding environment and performs automatic angle control and automatic illuminance control of the image capturing device and the lighting part, respectively, thereby acquiring a source image.

In addition, the biosignal measuring apparatus of the present disclosure determines changes in a near-infrared value and an R value of RGB obtained from video data, and measures and analyzes biosignals, thereby obtaining a result with higher reliability.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a configuration diagram of a biosignal measuring apparatus according to an embodiment of the present disclosure; and

FIGS. 2A, 2B, 2C, and 2D are views illustrating an example of the biosignal measuring apparatus according to the embodiment of the present disclosure.

### DETAILED DESCRIPTION OF THE INVENTION

Hereinafter, an embodiment of the present disclosure will be described in detail with reference to the accompanying drawings so that those skilled in the art to which the present disclosure pertains can easily implement it. However, the present disclosure is not limited to the embodiment described herein and may be implemented in various other forms. In addition, in the drawings, portions unrelated to the present disclosure have been omitted in order to clearly describe the present disclosure, and similar reference numerals are used throughout the specification for similar portions.

Throughout the present specification, when a certain part is described as being “connected (coupled, contacted, or joined)” to another part, it is intended to include not only cases where the two parts are directly connected, but also cases where the two parts are indirectly connected with another member placed therebetween. In addition, when a certain part is described as “including” a specific component, it is to be understood, unless expressly stated otherwise, that the part does not exclude the presence of other components but may further include additional components.

Terms used in the present specification are employed merely to describe a specific embodiment and are not intended to limit the present disclosure. Unless clearly indicated otherwise by the context, singular expressions also include plural expressions. In the present specification, terms such as “comprise” or “have” are intended to specify the presence of a feature, a number, a step, an operation, a component, a part, or combination thereof, but should not be construed as precluding the possibility of the presence or addition of one or more other features, numbers, steps, operations, components, parts, or combinations thereof.

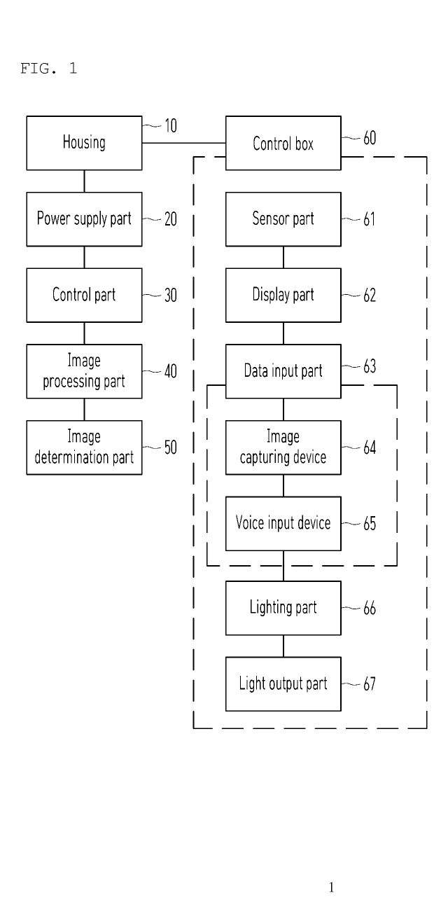

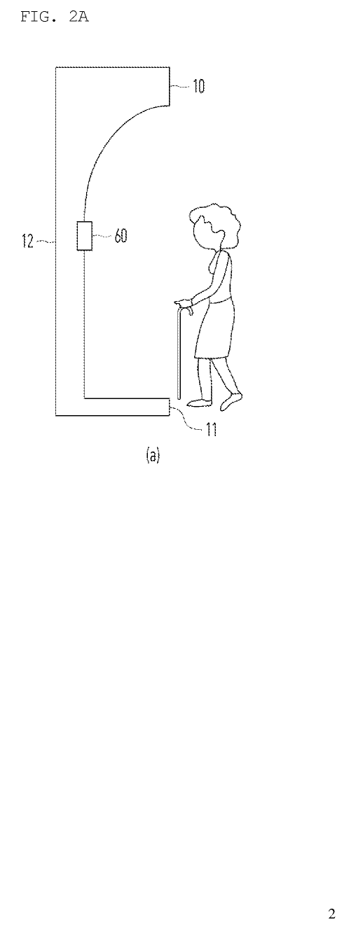

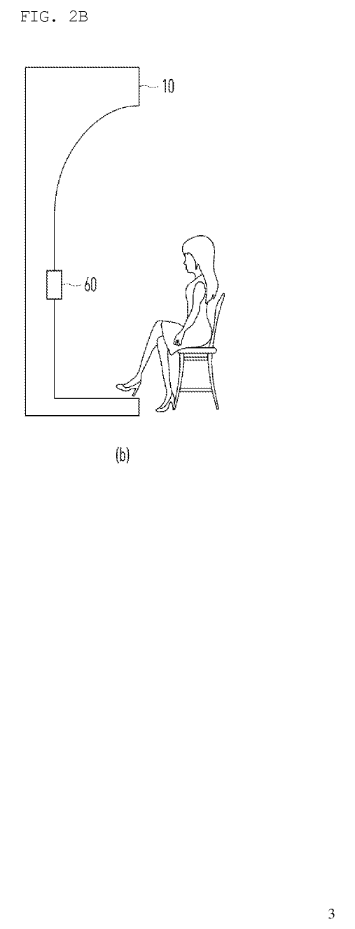

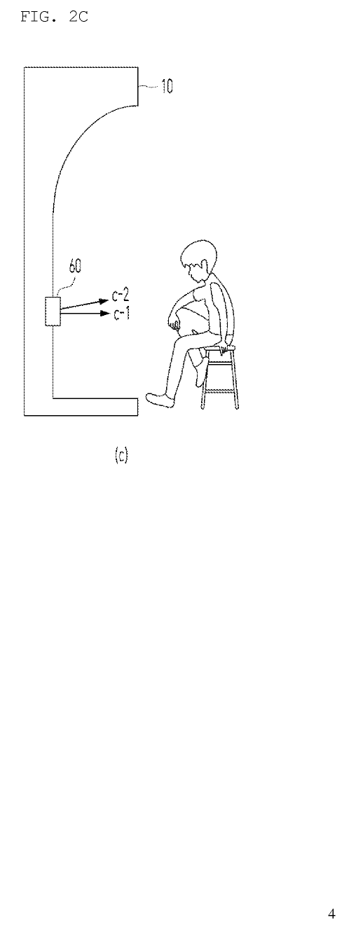

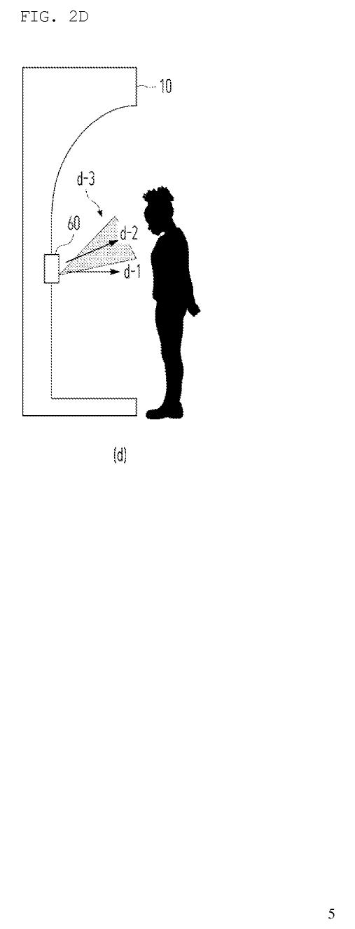

A biosignal measuring apparatus according to an embodiment of the present disclosure will be described with reference to FIGS. 1, 2A, 2B, 2C, and 2D.

FIG. 1 is a configuration diagram of the biosignal measuring apparatus according to an embodiment of the present disclosure, and FIGS. 2A, 2B, 2C, and 2D are views illustrating an example of the biosignal measuring apparatus according to the embodiment of the present disclosure.

Referring to FIGS.1 and 2, the biosignal measuring apparatus includes a housing 10 including a base plate 11, and a column 12 that is coupled to the base plate in a z-axis direction, is formed to have an internal hollow space, and has one surface formed in a curved shape.

A movement line is provided inside the column 12, and in the present disclosure, the movement line is preferably a rail, but is not limited thereto.

The biosignal measuring apparatus includes a power supply part 20 provided on a first side of the housing 10 and configured to supply power, a control part 30 provided on the first side of the housing 10 and configured to control operation by receiving power from the power supply part 20, an image processing part 40 connected to the control part 30 and configured to perform preprocessing and postprocessing of images, an image determination part 50 configured to determine quality of the image processed by the image processing part 40, and a control box 60 provided by being coupled to a second side of the housing 10 and configured to receive power from the power supply part 20 and to be operated by control of the control part 30.

The movement line operates by receiving power from the power supply part 20, is controlled by operation control of the control part 30, and includes a coupling member that is coupled to the control box 60.

A first end of the coupling member is coupled to and fixed to the movement line, and a second end of the coupling member is coupled to one side of the control box 60, so that the control box 60 moves together with movement of the movement line.

### The control box 60 includes:

multiple sensor parts 61 configured to measure biosignals of a user; a display part 62 configured to display biosignal measurement data of each of the sensor parts 61; a data input part 63 configured to acquire video or audio data of a user; a lighting part 66 whose operation is controlled by the control part 30; and a light output part 67 configured to illuminate a user with light of a specific wavelength.

In this case, the wavelength of light emitted from the light output part 67 is at least one of 660 nm and 940 nm, but is not limited thereto.

The sensor part 61 includes at least one of multiple illuminance sensors for detecting an amount of light in a surrounding environment, a position detection sensor for detecting a position of the control box 60, an angle detection sensor for detecting an angle of the control box 60, an impact detection sensor for detecting a collision of the control box 60, an identification sensor for identifying unique identification information of a user, and an iris recognition sensor for recognizing an iris of a user.

The control box 60 further includes an angle adjusting part provided detachably inside the data input part 63 so as to adjust an angle under control of the control part 30. In addition, the data input part 63 includes an image capturing device 64 coupled to the angle adjusting part so as to acquire a video image of a user, and a voice input device 65 configured to acquire voice data of the user.

The image capturing device 64 captures an image of a user, including an imaging region of the user after light is emitted from the light output part 67, and an angle of the image capturing device 64 is controlled so that the captured image approximates brightness, saturation, luminance, and illuminance values preset by the image determination part 50.

That is, first, the image capturing device 64 captures and acquires the image of a user, and the image determination part 50 analyzes the brightness, saturation, luminance, and illuminance of the captured image to determine whether they approximate the preset brightness, saturation, luminance, and illuminance values. Then, the angle of the image capturing device 64 is controlled in order to acquire an image that most closely approximates the preset values.

The lighting part 66 is detachably configured on one side of the image capturing device 64, and an angle thereof is controlled together when the angle of the image capturing device 64 is controlled by the angle control of the angle adjusting part as described above.

In this case, when the multiple illuminance sensors for detecting the amount of light in the surrounding environment of the sensor part 61 detect that an average sensing value is less than 600 lux, the lighting part 66 is controlled to illuminate a user with light.

Referring to FIGS. 2A to 2D, first, in FIG. 2A, in a case where a user is standing facing forward, the control box 60 is positioned in front of the user as shown in the drawing, and in a case where a user is seated as shown in FIG. 2B, the control box 60 is likewise positioned in front of the user.

On the other hand, as shown in FIG. 2C, when a user is sitting and gazing downward instead of forward, the control box 60 is directed toward the front of the user, but the angle of the image capturing unit 64, which is oriented in a c-1 direction, is adjusted in a c-2 direction by the control of the angle adjusting part.

That is, the control box 60 is positioned in front of a user along the movement line and controls the angle of the image capturing device 64 toward the imaging region of the user. In this case, while the control box 60 first moves along the movement line, the video image of the user is continuously captured by the image capturing device 64, and whether the captured video image corresponds to the biosignal imaging region of the user is determined by the image determination part 50. In the present disclosure, the biosignal imaging region preferably is the face of a user, but is not limited thereto.

In other words, while the control box 60 moves along the movement line, the image capturing device 64 continuously captures the video image of a user, and the image determination part 50 continuously determines whether the captured video image is a face image of the user. When the captured video image is determined to be the face image, the movement of the movement line stops, and the control box 60 stops.

In addition, in a case in which the surrounding environment of a user is dark and the user is looking downward as shown in FIG. 2D, when the average sensing value of the multiple illuminance sensors of the sensor part 61 is less than 600 Lux, the lighting part 66 illuminates the front of the user, and the control box 60 faces the front of the user. The image determination part 50 calculates the area of the face of the user in the video image captured by the image capturing device 64 of the control box 60. The control box 60 is moved along the movement line by the control part 30 so as to be positioned at a location which the area determined to be the face of the user is determined to be largest.

That is, in order to determine whether the surrounding environment is dark, when the average value of the illuminance sensors of the sensor part 61 is less than 600 Lux, light is emitted toward the front, since the area of the biosignal measuring region of a user may decrease depending on the viewing angle of the user, the control box 60 moves along the movement line to infer the viewing direction of the user, the image determination part 50 continuously analyzes the video image of the user captured while the control box 60 moves along the movement line to calculate the facial area of the user, and the control box 60 is positioned at a location at which the facial area is determined to be largest, and the image capturing device 64, which was previously oriented in a d-1 direction, is angle-adjusted to a d-2 direction by the control of the angle adjusting part so as to correspond to the viewing direction of the user.

At this time, due to the angular movement of the image capturing device 64, the lighting part 66 is also angularly moved to emit light toward the front of the user.

Although the embodiment of the present disclosure has been described in detail above, the scope of the present disclosure is not limited thereto, and various modifications and improvements by those skilled in the art using the basic concepts of the present disclosure as defined in the following claims also fall within the scope of the present disclosure.

What is claimed is:

1. A biosignal measuring apparatus comprising:
a housing including a base plate, and a column that is coupled to the base plate in a z-axis direction, is formed to have an internal hollow space, and has one surface formed in a curved shape;
a power supply part provided on a first side of the housing and configured to supply power;
a control part provided on the first side of the housing and configured to control operation by receiving power from the power supply part;
an image processing part connected to the control part and configured to perform preprocessing and postprocessing of an image;
an image determination part configured to determine quality of the image processed by the image processing part; and
a control box provided by being coupled to a second side of the housing, and configured to receive power from the power supply part and to be operated by control of the control part,
wherein the control box includes:
multiple sensor parts configured to measure biosignals of a user;
a display part configured to display biosignal measurement data of each of the sensor parts;
a data input part configured to acquire video or audio data of a user;
a lighting part whose operation is controlled by the control part; and
a light output part configured to illuminate a user with light of a specific wavelength.

2. The biosignal measuring apparatus of claim 1, wherein a movement line is provided inside the column, wherein the movement line is a rail.

3. The biosignal measuring apparatus of claim 2, wherein the movement line operates by receiving power from the power supply part, is controlled by operation control of the control part, and includes a coupling member that is coupled to the control box.

4. The biosignal measuring apparatus of claim 3, wherein a first end of the coupling member is coupled to and fixed to the movement line, and a second end of the coupling member is coupled to one side of the control box, so that the control box moves together with movement of the movement line.

5. The biosignal measuring apparatus of claim 1, wherein a wavelength of light emitted from the light output part is at least one of 660nm and 940nm.

6. The biosignal measuring apparatus of claim 1, wherein the sensor part includes at least one of multiple illuminance sensors for detecting an amount of light in a surrounding environment,
a position detection sensor for detecting a position of the control box,
an angle detection sensor for detecting an angle of the control box,
an impact detection sensor for detecting a collision of the control box,
an identification sensor for identifying unique identification information of a user, and
an iris recognition sensor for recognizing an iris of a user.

7. The biosignal measuring apparatus of claim 1, wherein the control box further includes an angle adjusting part provided detachably inside the data input part and configured to adjust an angle under control of the control part.

8. The biosignal measuring apparatus of claim 7, wherein the data input part includes an image capturing device coupled to the angle adjusting part so as to acquire a video image of a user, and a voice input device configured to acquire voice data of a user.

9. The biosignal measuring apparatus of claim 8, wherein the image capturing device captures an image of a user, including an imaging region of the user after light is emitted from the light output part, and an angle of the image capturing device is controlled so that the captured image approximates brightness, saturation, luminance, and illuminance values preset by the image determination part.

10. The biosignal measuring apparatus of claim 1, wherein the lighting part is detachably provided on one side of an image capturing device, and an angle thereof is controlled together when an angle of the image capturing device is controlled by angle control of an angle adjusting part.

11. The biosignal measuring apparatus of claim 10, wherein when an average sensing value of multiple illuminance sensors of the sensor part that detect an amount of light of a surrounding environment is less than 600 Lux, the lighting part is controlled to illuminate a user with light thereof.
